(19) United States
(12) Patent Application Publication
(10) Pub. No.: US 2025/0310043 A1
(43) Pub. Date: Oct. 2, 2025

(54) Physical Downlink Control Channel Monitoring for Inter-Cell Beam Management

(71) Applicant: Nokia Technologies Oy, Espoo (FI)

(72) Inventors: Keeth Saliya Jayasinghe LADDU, Espoo (FI); Timo KOSKELA, Oulu (FI); Sami-Jukka HAKOLA, Oulu (FI)

(21) Appl. No.: 19/234,365

(22) Filed: Jun. 11, 2025

Related U.S. Application Data
(63) Continuation of application No. 18/696,170, filed on Mar. 27, 2024.
(60) Provisional application No. 63/250,319, filed on Sep. 30, 2021.

(51) Int. Cl. H04L 5/00; H04W 48/12; H04W 72/02

(52) U.S. Cl. CPC H04L 5/0023; H04L 5/0035; H04L 5/0053; H04L 5/0098; H04W 48/12; H04W 72/02

(57) ABSTRACT

Systems, methods, apparatuses, and computer-readable storage mediums are provided for enhancements to physical downlink control channel monitoring for inter-cell scenarios in case of a multiple input multiple output environment. In an example implementation, the method may comprise determining, by a network device of a communication network, to monitor physical downlink control channel candidates in overlapping monitoring occasions of two or more control resource sets of the communication network, wherein the two or more control resource sets are using at least two different QCL-TypeD on an active downlink bandwidth part of one or more cells; and selecting a first control resource set using a first QCL-TypeD and a second control resource set using a second QCL-TypeD for monitoring at least two of the physical downlink control channel candidates, wherein the selection of the first control resource set is based on common search space sets and/or user specific search space sets of at least one control resource set on active downlink bandwidth part of at least one cell that associated with one or more physical cell identifiers, and the selection of the second control resource set is based on user specific search space sets of at least one control resource set on active downlink bandwidth part of at least one cell that associated with at least two physical cell identifiers.

### TECHNICAL FIELD

The teachings in accordance with the exemplary embodiments of this invention relate generally to enhancements to physical downlink control channel monitoring and, more specifically, relate to enhancements to physical downlink control channel monitoring for inter-cell scenarios in case of a multiple input multiple output environment.

### BACKGROUND

This section is intended to provide a background or context to the invention that is recited in the claims. The description herein may include concepts that could be pursued, but are not necessarily ones that have been previously conceived or pursued. Therefore, unless otherwise indicated herein, what is described in this section is not prior art to the description and claims in this application and is not admitted to be prior art by inclusion in this section.

Certain abbreviations that may be found in the description and/or in the Figures are herewith defined as follows:

| | |
|---|---|
| BWP | bandwidth part |
| CCE | control channel element |
| CORESET | control resource set |
| DCI | downlink control information |
| SS | search space |
| USS | user specific search space |
| CSS | common search space |
| QCL | quasi co-location |
| PCI | physical cell identifier |
| PDCCH | physical downlink control channel |
| REG | resource-element group |
| RNTI | radio network temporary identifier |
| RRC | radio resource control |
| TCI | transmission configuration indication |
| TRP | transmission/reception point |
| UE | user equipment |

Regarding the inter-cell beam management there have been discussions regarding the monitoring of serving cell and non-serving cell (TRP with different PCI than serving cell) common and dedicated channels. In practise it means that UE can be configured for inter-cell operation where UE may communicate (transmit or receive or both) with a serving cell and one or of cells with different PCIs than serving cell.

Example embodiments of this invention relate to enhancement for multi-beam operation.

### BRIEF DESCRIPTION OF THE DRAWINGS

The above and other aspects, features, and benefits of various embodiments of the present disclosure will become more fully apparent from the following detailed description with reference to the accompanying drawings, in which like reference signs are used to designate like or equivalent elements. The drawings are illustrated for facilitating better understanding of the embodiments of the disclosure and are not necessarily drawn to scale, in which:

FIG. 1 shows a procedure for generating PDCCH from DCI;

FIG. 2 shows an example scenario for Variant 1 in accordance with example embodiments of the invention, where selection of the first QCL TypeD is based on all cells (CSS rule applied);

FIG. 3 shows an example scenario for Variant 2 in accordance with example embodiments of the invention, where selection of the first QCL TypeD is based on cell2 (CSS rule applied);

FIG. 4 shows an example scenario for Variant 3 in accordance with example embodiments of the invention, where selection of the first QCL TypeD is based on cell1 (USS rule applied);

FIG. 5 shows a high level block diagram of various devices used in carrying out various aspects of the invention; and

FIG. 6 shows a method in accordance with example embodiments of the invention which may be performed by an apparatus.

### DETAILED DESCRIPTION

Example embodiments of the invention provide at least a method and apparatus for enhancements to physical downlink control channel monitoring for inter-cell scenarios in case of a multiple input multiple output environment.

As similarly stated above, for inter-cell beam management there have been discussions regarding the monitoring of serving cell and non-serving cell (TRP with different PCI than serving cell) common and dedicated channels. In practise it means that UE can be configured for inter-cell operation where UE may communicate (transmit or receive or both) with a serving cell and one or of cells with different PCIs than serving cell.

Example embodiments of this invention relate to NW feMIMO and an objective at the time of this application states the enhancement for multi-beam operation by supporting inter-cell beam management.

### Background for PDCCH, CORESET and Search Space Set

### Channel Coding and Downlink Control Information (DCI) Construction

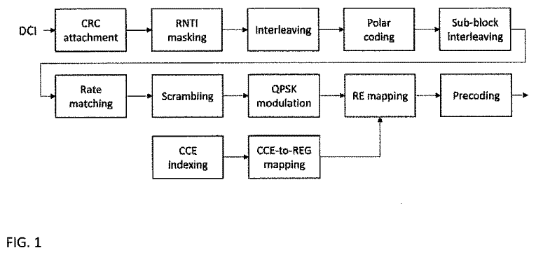

A procedure for generating a PDCCH from DCI is illustrated in FIG. 1.

Regarding the procedure in FIG. 1, if the size of the DCI format is less than 12 bits, a few zero padding bits will be appended until the payload size equals 12 bits. For the DCI payload bits, a 24-bit cyclic redundancy check (CRC) is calculated and appended to the payload. The CRC allows the UE to detect the presence of errors in the decoded DCI payload bits. After the CRC is attached, the last 16 CRC bits are masked with a corresponding identifier, referred to as a radio network temporary identifier (RNTI). Using the RNTI mask, the UE can detect the DCI for its unicast data and distinguish sets of DCI with different purposes that have the same payload size. The CRC attached bits are then interleaved to distribute the CRC bits among the information bits. The interleaver supports a maximum input size of 164 bits. This means that DCI without CRC can have at most 140 of payload bits. The bits are then encoded by the Polar encoder to protect the DCI against errors during transmission. The encoder output is processed using a sub-block interleaver and then rate matched to fit the allocated payload resource elements (REs) of the DCI.

The payload bits of each DCI are separately scrambled by a scrambling sequence generated from the length-31 Gold sequence. The scrambling sequence is initialized by the physical layer cell identity of the cell or by a UE specific scrambling identity and a UE specific cell RNTI (C-RNTI). After the scrambled DCI bit sequence is Quadrature Phase Shift Keying (QPSK) modulated, the complex-valued modulation symbols are mapped to physical resources in units referred to as control channel elements (CCEs). Each CCE consists of six resource element groups (REGs), where a REG is defined as one PRB in one OFDM symbol which contains nine REs for the PDCCH payload and three demodulation reference signal (DMRS) REs. For each DCI, 1, 2, 4, 8, or 16 CCEs can be allocated, where the number of CCEs for a DCI is denoted as aggregation level (AL). With QPSK modulation, a CCE contains 54 payload REs and therefore can carry 108 bits. This requires the output size of the rate matching block to be L.108, where L is the associated AL. Based on the channel environment and available resources, the gNB can adaptively choose a proper AL for a DCI to adjust the code rate.

### Control Resource Sets (CORESETs)

A DCI with AL L is mapped to physical resources in a given BWP, where necessary parameters such as frequency and time domain resources, and scrambling sequence identity for the DMRS for the PDCCH are configured to a UE by means of control resource set (CORESET). A UE may be configured with up to three CORESETs in Rel15 and up to five CORESETs in Rel16 (for multi-DCI multi-TRP operation) on each of up to four BWPs on a serving cell. In general, CORESETs are configured in units of six PRBs on a six PRB frequency grid and one, two, or three consecutive OFDM symbols in the time domain.

A DCI of AL L comprises L continuously numbered CCEs, and the CCEs are mapped on a number of REGs in a CORESET. NR supports distributed and localized resource allocation for a DCI in a CORESET. This is done by configuring interleaved or non-interleaved CCE-to-REG mapping for each CORESET. For interleaved CCE-to-REG mapping, REG bundles constituting the CCEs for a PDCCH are distributed in the frequency domain in units of REG bundles. A REG bundle is a set of indivisible resources consisting of neighboring REGs. A REG bundle spans across all OFDM symbols for the given CORESET. Once the REGs corresponding to a PDCCH are determined, the modulated symbols of the PDCCH are mapped to the REs of the determined REGs in the frequency domain first and the time domain second, i.e. in increasing order of the RE index and symbol index, respectively.

### PDCCH Monitoring—Search Space Sets (SSSets)

The UE performs blind decoding for a set of PDCCH candidates. PDCCH candidates to be monitored are configured for a UE by means of search space (SS) sets. There are two SS set types: common SS (CSS) set, which is commonly monitored by a group of UEs in the cell, and UE-specific SS (USS) set, which is monitored by an individual UE. A UE can be configured with up to 10 SS sets each for up to four BWPs in a serving cell. In general, SS set configuration provides a UE with the SS set type (CSS set or USS set), DCI format(s) to be monitored, monitoring occasion, and the number of PDCCH candidates for each AL in the SS set.

An SS set with index s is associated with only one CORESET with index p. The UE determines the slot for monitoring the SS set with index s based on the higher layer parameters for periodicity k, offset o, and duration d, where periodicity k and offset o provide a starting slot and duration d provides the number of consecutive slots where the SS set is monitored starting from the slot identified by k and o.

### PDCCH Monitoring—PDCCH Candidate Hashing

The mapping of PDCCH candidates of an SS set to CCEs of the associated CORESET is implemented by means of a hash function. The hash function randomizes the allocation of the PDCCH candidates within CORESET.

In standards releases at the time of this application there is a limitation for monitoring PDCCH candidates in overlapping monitoring occasions if the CORESETs have different QCL-TypeD properties. A certain rule is applied to prioritize monitoring of PDCCH candidates such that “If a UE is configured for single cell operation or for operation with carrier aggregation in a same frequency band, and monitors PDCCH candidates in overlapping PDCCH monitoring occasions in multiple CORESETs that have same or different QCL-TypeD properties on active DL BWP(s) of one or more cells. The UE monitors PDCCHs only in a CORESET, and in any other CORESET from the multiple CORESETs having same QCL-TypeD properties as the CORESET, on the active DL BWP of a cell from the one or more cells. The CORESET corresponds to the CSS set with the lowest index in the cell with the lowest index containing CSS, if any; otherwise, to the USS set with the lowest index in the cell with lowest index. Further, the lowest USS set index is determined over all USS sets with at least one PDCCH candidate in overlapping PDCCH monitoring occasions.

If the same rule is applied for inter-cell beam management in overlapping search spaces on CORESETs, the PDCCH candidates (mainly from non-serving cell/cell with different PCI than serving-cell) that schedule UE dedicated signals/channels will not be monitored. If the non-serving cell PDCCH candidates are not monitored, the UE may not be able to be scheduled with UE dedicated signals and channels.

One idea in accordance with example embodiments of the invention includes Pseudo code for monitoring two different QCL TypeDs as shown in different variants as described herein.

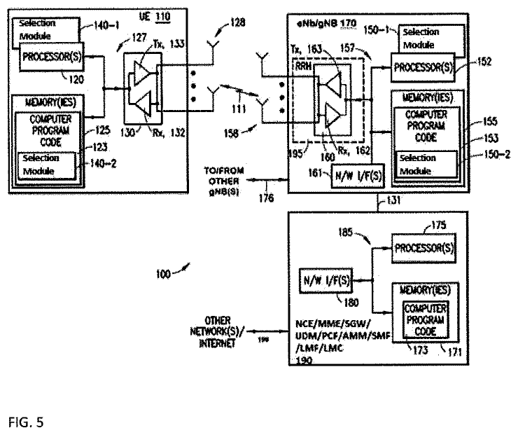

Before describing the example embodiments of the invention in further detail reference is made to FIG. 5. FIG. 5 shows a block diagram of one possible and non-limiting exemplary system in which the exemplary embodiments may be practiced.

As shown in FIG. 5, a user equipment (UE) 110 is in wireless communication with a wireless network 100. A UE is a wireless, typically mobile device that can access a wireless network. The UE 110 includes one or more processors 120, one or more memories 125, and one or more transceivers 130 interconnected through one or more buses 127. Each of the one or more transceivers 130 includes a receiver Rx, 132 and a transmitter Tx 133. The one or more buses 127 may be address, data, or control buses, and may include any interconnection mechanism, such as a series of lines on a motherboard or integrated circuit, fiber optics or other optical communication equipment, and the like. The one or more transceivers 130 are connected to one or more antennas 128. The one or more memories 125 include computer program code 123. The UE 110 may include a Selection Module 140 which is configured to perform the example embodiments of the invention as described herein. The Selection Module 140 may be implemented in hardware by itself of as part of the processors and/or the computer program code of the UE 110. The Selection Module 140 comprising one of or both parts 140-1 and/or 140-2, which may be implemented in a number of ways. The Selection Module 140 may be implemented in hardware as

Selection Module 140-1, such as being implemented as part of the one or more processors 120. The Selection Module 140-1 may be implemented also as an integrated circuit or through other hardware such as a programmable gate array. In another example, the Selection Module 140 may be implemented as Selection Module 140-2, which is implemented as computer program code 123 and is executed by the one or more processors 120. Further, it is noted that the Selection Modules 140-1 and/or 140-2 are optional. For instance, the one or more memories 125 and the computer program code 123 may be configured, with the one or more processors 120, to cause the user equipment 110 to perform one or more of the operations as described herein. The UE 110 communicates with gNB 170 via a wireless link 111.

The gNB 170 (NR/5G Node B or possibly an evolved NB) is a base station (e.g., for LTE, long term evolution) that provides access by wireless devices such as the UE 110 to the wireless network 100. The gNB 170 includes one or more processors 152, one or more memories 155, one or more network interfaces (N/W I/F(s)) 161, and one or more transceivers 160 interconnected through one or more buses 157. Each of the one or more transceivers 160 includes a receiver Rx 162 and a transmitter Tx 163. The one or more transceivers 160 are connected to one or more antennas 158. The one or more memories 155 include computer program code 153. The gNB 170 includes a Selection Module 150 which is configured to perform example embodiments of the invention as described herein. The Selection Module 150 may comprise one of or both parts 150-1 and/or 150-2, which may be implemented in a number of ways. The Selection Module 150 may be implemented in hardware by itself or as part of the processors and/or the computer program code of the gNB 170. Selection Module 150-1, such as being implemented as part of the one or more processors 152. The Selection Module 150-1 may be implemented also as an integrated circuit or through other hardware such as a programmable gate array. In another example, the Selection Module 150 may be implemented as Selection Module 150-2, which is implemented as computer program code 153 and is executed by the one or more processors 152. Further, it is noted that the Selection Modules 150-1 and/or 150-2 are optional. For instance, the one or more memories 155 and the computer program code 153 may be configured to cause, with the one or more processors 152, the gNB 170 to perform one or more of the operations as described herein. The one or more network interfaces 161 communicate over a network such as via the links 176 and 131. Two or more gNB 170 may communicate using, e.g., link 176. The link 176 may be wired or wireless or both and may implement, e.g., an X2 interface.

The one or more buses 157 may be address, data, or control buses, and may include any interconnection mechanism, such as a series of lines on a motherboard or integrated circuit, fiber optics or other optical communication equipment, wireless channels, and the like. For example, the one or more transceivers 160 may be implemented as a remote radio head (RRH) 195, with the other elements of the gNB 170 being physically in a different location from the RRH, and the one or more buses 157 could be implemented in part as fiber optic cable to connect the other elements of the gNB 170 to the RRH 195.

It is noted that description herein indicates that “cells” perform functions, but it should be clear that the gNB that forms the cell will perform the functions. The cell makes up part of a gNB. That is, there can be multiple cells per gNB.

The wireless network 100 may include a NCE/MME/SGW/UDM/PCF/AMM/SMF/LMF/LMC 190, which can comprise a network control element (NCE), and/or serving gateway (SGW) 190, and/or MME (Mobility Management Entity) and/or SGW (Serving Gateway) functionality, and/or user data management functionality (UDM), and/or PCF (Policy Control) functionality, and/or Access and Mobility (AMF) functionality, and/or Session Management (SMF) functionality, Location Management Function (LMF), Location Management Component (LMC) and/or Authentication Server (AUSF) functionality and which provides connectivity with a further network, such as a telephone network and/or a data communications network (e.g., the Internet), and which is configured to perform any 5G and/or NR operations in addition to or instead of other standards operations at the time of this application. The NCE/MME/SGW/UDM/PCF/AMM/SMF/LMF/LMC 190 is configurable to perform operations in accordance with example embodiments of the invention in any of an LTE, NR, 5G and/or any standards based communication technologies being performed or discussed at the time of this application.

The gNB 170 is coupled via a link 131 to the NCE/MME/SGW/UDM/PCF/AMM/SMF/LMF/LMC 190. The link 131 may be implemented as, e.g., an S1 interface or N2 interface. The NCE/MME/SGW/UDM/PCF/AMM/SMF/LMF/LMC 190 includes one or more processors 175, one or more memories 171, and one or more network interfaces (N/W I/F(s)) 180, interconnected through one or more buses 185. The one or more memories 171 include computer program code 173. The one or more memories 171 and the computer program code 173 are configured to, with the one or more processors 175, cause the NCE/MME/SGW/UDM/PCF/AMM/SMF/LMF/LMC 190 to perform one or more operations. In addition, the NCE/MME/SGW/UDM/PCF/AMM/SMF/LMF/LMC 190, as are the other devices, is equipped to perform operations of such as by controlling the UE 110 and/or gNB 170 for 5G and/or NR operations in addition to any other standards operations implemented or discussed at the time of this application.

The wireless network 100 may implement network virtualization, which is the process of combining hardware and software network resources and network functionality into a single, software-based administrative entity, a virtual network. Network virtualization involves platform virtualization, often combined with resource virtualization. Network virtualization is categorized as either external, combining many networks, or parts of networks, into a virtual unit, or internal, providing network-like functionality to software containers on a single system. Note that the virtualized entities that result from the network virtualization are still implemented, at some level, using hardware such as processors 152 or 175 and memories 155 and 171, and also such virtualized entities create technical effects.

The computer readable memories 125, 155, and 171 may be of any type suitable to the local technical environment and may be implemented using any suitable data storage technology, such as semiconductor based memory devices, flash memory, magnetic memory devices and systems, optical memory devices and systems, fixed memory and removable memory. The computer readable memories 125, 155, and 171 may be means for performing storage functions. The processors 120, 152, and 175 may be of any type suitable to the local technical environment, and may include one or more of general purpose computers, special purpose computers, microprocessors, digital signal processors (DSPs) and processors based on a multi-core processor architecture, as non-limiting examples. The processors 120, 152, and 175 may be means for performing functions and other functions as described herein to control a network device such as the UE 110, gNB 170, and/or NCE/MME/SGW/UDM/PCF/AMM/SMF/LMF/LMC 190 as in FIG. 5.

It is noted that functionality(ies), in accordance with example embodiments of the invention, of any devices as shown in FIG. 5 e.g., the UE 110 and/or gNB 170 can also be implemented by other network nodes, e.g., a wireless or wired relay node (a.k.a., integrated access and/or backhaul (IAB) node). In the IAB case, UE functionalities may be carried out by MT (mobile termination) part of the IAB node, and gNB functionalities by DU (Data Unit) part of the IAB node, respectively. These devices can be linked to the UE 110 as in FIG. 5 at least via the wireless link 111 and/or via the NCE/MME/SGW/UDM/PCF/AMM/SMF/LMF/LMC 190 using link 199 to Other Network(s)/Internet as in FIG. 5.

In general, the various embodiments of the user equipment 110 can include, but are not limited to, cellular telephones such as smart phones, tablets, personal digital assistants (PDAs) having wireless communication capabilities, portable computers having wireless communication capabilities, image capture devices such as digital cameras having wireless communication capabilities, gaming devices having wireless communication capabilities, music storage and playback appliances having wireless communication capabilities, Internet appliances permitting wireless Internet access and browsing, tablets with wireless communication capabilities, as well as portable units or terminals that incorporate combinations of such functions, in addition for vehicles such as autos and/or truck and arial vehicles such as manned or unmanned arial vehicle and as well as portable units or terminals that incorporate combinations of such functions.

### Precondition

If a UE:
is configured for single cell operation or for operation with carrier aggregation in a same frequency band, and
monitors PDCCH candidates in overlapping PDCCH monitoring occasions in multiple CORESETs that have been configured with same or different qcl-Type set to ‘typeD’ properties on active DL BWP(s) of one or more cells, and
has at least one cell that with a CORESET corresponding to the CSS set and a CORESET corresponding to the USS set where the CORESETs have been activated with TCI states (joint TCI or DL TCI) that associated with different qcl-Type set to ‘typeD’ properties and the TCI state of the CORESET corresponding to the USS set is associated with a physical cell ID different from that of the serving cell

### Selection of the First QCL TypeD

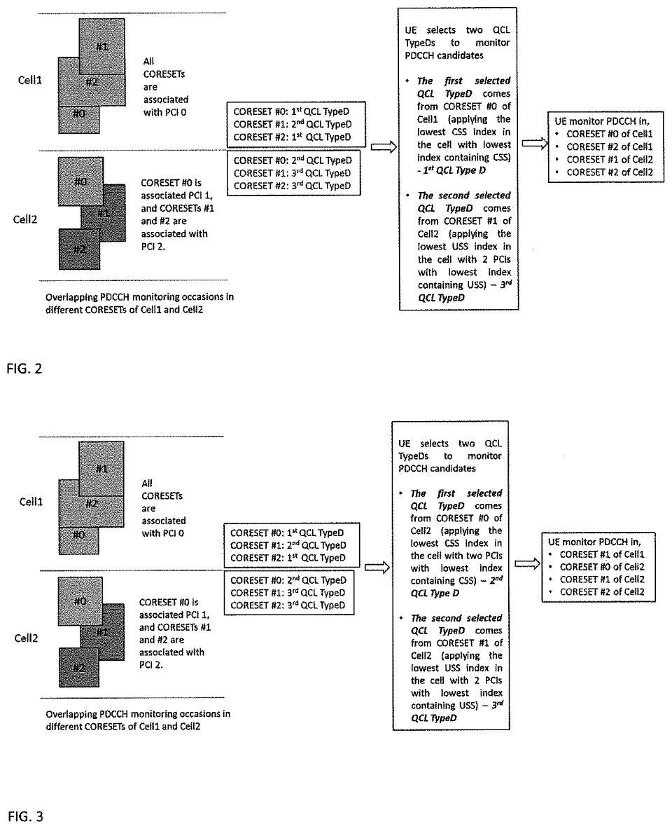

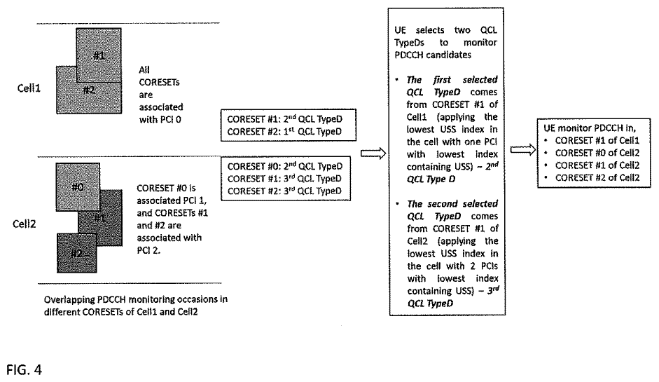

FIG. 2, FIG. 3, and FIG. 4 each show example scenarios of operations in accordance with example embodiments of the invention.

In FIG. 2, FIG. 3, and FIG. 4 the cell2 is applying inter-cell beam management, i.e., cell2 associated with 2 PCIs. In the examples, CORESET #0 in each cell is associated with CSS sets. CORESET #1/2 are considered to be associated only with USS sets, and the lowest index among USS sets is assumed to be always in CORESET #1 (within a cell).

In FIG. 2, based on variant 1, the first QCL type D is determined by the CSS set with the lowest index (considering both cells), which is CORESET #0 in cell1, and the second QCL Type D is determined by the cell2 USS sets.

As shown in FIG. 2 the UE selects two QCL TypeDs to monitor PDCCH candidates. The first selected QCL TypeD comes from CORESET #0 of Cell1 (applying the lowest CSS index in the cells with one or two PCIs with lowest index containing CSS)—1st QCL Type D. The second selected QCL TypeD comes from CORESET #1 of Cell2 (applying the lowest USS index in the cell with 2 PCIs with lowest index containing USS)—3rd QCL TypeD. As shown in FIG. 2 the UE monitors PDCCH in CORESET #0 of Cell1, CORESET #2 of Cell1, CORESET #1 of Cell2, and CORESET #2 of Cell2.

In FIG. 3, based on variant 2, the first QCL type D is determined by the CSS set with the lowest index within cell2 (considering priority on the cell that support inter-cell beam management), which is CORESET #0 in cell2, and the second QCL Type D is determined by the cell2 USS sets.

As shown in FIG. 3 the UE selects two QCL TypeDs to monitor PDCCH candidates. The first selected QCL TypeD comes from CORESET #0 of Cell2 (applying the lowest CSS index in the cell with two PCI with lowest index containing CSS)—2nd QCL Type D. The second selected QCL TypeD comes from CORESET #1 of Cell2 (applying the lowest USS index in the cell with 2 PCIs with lowest index containing USS)—3rd QCL TypeD. As shown in FIG. 3 the UE monitors PDCCH in CORESET #1 of Cell1, CORESET #0 of Cell2, CORESET #1 of Cell2, and CORESET #2 of Cell2.

In FIG. 4, based on variant 3, the first QCL type D is determined by the USS set with the lowest index within cell1 (note that e.g., there may be no CSS in cell1 in this example), and the second QCL Type D is determined by the cell2 USS sets.

As shown in FIG. 4 the UE selects two QCL TypeDs to monitor PDCCH candidates. The first selected QCL TypeD comes from CORESET #1 of Cell1 (applying the lowest USS index in the cell with one PCI with lowest index containing USS)—2nd QCL Type D. The second selected QCL TypeD comes from CORESET #1 of Cell2 (applying the lowest USS index in the cell with 2 PCIs with lowest index containing USS)—3rd QCL TypeD. As shown in FIG. 4 the UE monitors PDCCH in CORESET #1 of Cell1, CORESET #0 of Cell2, CORESET #1 of Cell2, CORESET #2 of Cell2.

For selection of a first QCL TypeD the UE monitors PDCCH candidates in a CORESET, and in any other CORESET from the multiple CORESETs that have been configured with qcl-Type set to same ‘typeD’ properties as the CORESET, on the active DL BWP of a cell from the one or more cells. Regarding the variants in accordance with example embodiments of the invention these include operations as follows:
Variant 1: the CORESET corresponds to the CSS set with the lowest index in the cell with the lowest index containing CSS, if any; otherwise, to the USS set with the lowest index in the cell with lowest index among the cells that are not having a CORESET corresponding to the USS associated with a physical cell ID different from that of the cell. In other words, CSS rule, i.e., CSS sets are applied when selecting the QCL TypeD, follows legacy method by considering all cells (i.e., with one PCI or two PCIs). USS rule, i.e., USS sets are applied when selecting the QCL TypeD, follows the cells only with one PCI; and
Variant 2: the CORESET corresponds to the CSS set with the lowest index in the cell with the lowest index among the cells that are having a CORESET corresponding to the USS associated with a physical cell ID different from that of the cell and containing CSS, if any; otherwise, to the USS set with the lowest index in the cell with lowest index among the cells that are not having a CORESET corresponding to the USS associated with a physical cell ID different from that of the cell In other words, CSS rule follows only cells with two PCIs. USS rule follows the cells only with one PCI; and
Variant 3: the CORESET corresponds to the CSS set with the lowest index in the cell with the lowest index among the cells that are not having a CORESET corresponding to the USS associated with a physical cell ID different from that of the cell and containing CSS, if any; otherwise, to the USS set with the lowest index in the cell with lowest index among the cells that are not having a CORESET corresponding to the USS associated with a physical cell ID different from that of the cell in other words, CSS rule follows the cells only with one PCI. USS rule follows the cells only with one PCI.
Variant 4: the CORESET corresponds to the CSS set with the lowest index in the cell with the lowest index containing CSS, if any; otherwise, to the USS set with the lowest index in the cell with lowest index containing USS. Here, CSS rule for selecting the CORESET and USS rule for selecting the CORESET does not consider any additional aspects related to the number of PCIs associated with a cell.

For selection of the second QCL TypeD the UE further monitors PDCCH candidates of the USS set in a CORESET, and in any other CORESET from the multiple CORESETs that have been configured with qcl-Type set to same ‘typeD’ properties as the CORESET, on the active DL BWP of a cell from the one or more cells, and
the CORESET corresponds to the USS set with the lowest index in the cell among the cells that are having a CORESET corresponding to the USS associated with a physical cell ID different from that of the serving cell (second QCL type D always from the USS rule follows the cells only with two PCI).

Note: the cell with 2 PCIs here refers to the inter-cell beam management where the serving cell can be configured with a CORESET that is configured with USS and is indicated with active TCI state that is associated with a PCI different than the serving cell.

In an example, in any of the embodiments herein, the single cell operation may comprise refer to either intra-cell or inter-cell beam management.

In accordance with further embodiments of the invention, in inter-cell beam management and/or inter-cell mTRP there may be one or more CORESET(s) configured for the UE. Each CORESET may be further associated with CSS and/or USS. As an example, there may be CORESET(s) that are configured with CSS only, CORESETs with USS only or there may be CORESET(s) that are configured with both USS and CSS. For inter-cell operation network (e.g., gNB) may indicate UE to monitor dedicated channels (such as PDCCH, monitored on USS) on non-serving cell (TRP/cell with different PCI than serving cell) while the common channels (monitored on CCS) are monitored from the serving cell. The monitoring indication for the dedicated channel may be an activation of a TCI State (via DCI or MAC CE) for one or more CORESETs where the RS indicated by the active TCI state is associated with a cell with PCI different than serving cell. UE may be restricted to monitor only dedicated channels on the cell with PCI different than serving cell. In some example embodiments, if UE receives beam indication (activation of TCI state for at least PDCCH reception) for a CORESET that is associated with USS and CSS where the TCI state indicates an RS associated with different PCI than serving cell, UE may not monitor the CSS for downlink control information for the respective CORESET. In other words, the beam indication applies only for the USS monitoring. In some example embodiments, if UE receives beam indication (activation of TCI state for at least PDCCH reception) for a CORESET that is associated with USS and CSS where the TCI state indicates an RS associated with different PCI than serving cell, UE may not monitor the USS or CSS for downlink control information for the respective CORESET. In other words, the beam indication does not apply for the CORESET with both USS and CSS. In some example embodiments, if UE receives beam indication (activation of TCI state for at least PDCCH reception) for a CORESET that is associated with USS and CSS where the TCI state indicates an RS associated with different PCI than serving cell, UE may monitor the CSS for downlink control information for the respective CORESET according to the previously active TCI State for the serving cell and may not monitor USS. In other words, UE does not monitor USS for the CORESET (and may only monitor CSS part wherein the CSS is monitored according to the latest TCI state indicating serving cell RS). In some example embodiments, if UE receives beam indication (activation of TCI state for at least PDCCH reception) for a CORESET that is associated with USS and CSS where the TCI state indicates an RS associated with different PCI than serving cell, UE may not monitor any SS (CSS/USS) on the CORESET. In yet another example embodiment, network indicate to UE or configure UE e.g., in an RRC, MAC CE or DCI signaling to monitor SS (search spaces) according to example embodiments herein when a CORESET is activated with a TCI state indicating an RS associated with different PCI than serving cell.

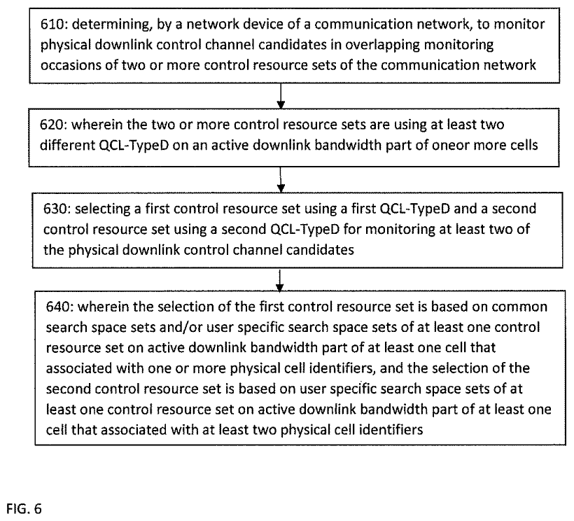

FIG. 6 illustrates operations which may be performed by a device such as, but not limited to, a network device (e.g., the UE 110 as in FIG. 5). As shown in step 610 of FIG. 6 there is determining, by a network device of a communication network, to monitor physical downlink control channel candidates in overlapping monitoring occasions of two or more control resource sets of the communication network. As shown in step 620 of FIG. 6 wherein the two or more control resource sets are using at least two different QCL-TypeD on an active downlink bandwidth part of one or more cells. As shown in step 630 of FIG. 6 there is selecting a first control resource set using a first QCL-TypeD and a second control resource set using a second QCL-TypeD for monitoring at least two of the physical downlink control channel candidates. Then as shown in step 640 of FIG. 6 wherein the selection of the first control resource set is based on common search space sets and/or user specific search space sets of at least one control resource set on active downlink bandwidth part of at least one cell that associated with one or more physical cell identifiers, and the selection of the second control resource set is based on user specific search space sets of at least one control resource set on active downlink bandwidth part of at least one cell that associated with at least two physical cell identifiers.

In accordance with the example embodiments as described in the paragraph above, wherein the at least one non-transitory memory including computer program code is configured with the at least one processor to cause the apparatus to also monitor physical downlink control channel candidates in overlapping monitoring occasions of the two or more control resource sets associated with the first QCL-typeD and second QCL-typeD.

In accordance with the example embodiments as described in the paragraphs above, wherein the first and the second control resource sets have been activated with transmission configuration indication states.

In accordance with the example embodiments as described in the paragraphs above, wherein the transmission configuration indication states comprise at least one of a joint transmission configuration indication state or a downlink transmission configuration indication state associated with the at least two different qcl-Type set to typeD properties.

In accordance with the example embodiments as described in the paragraphs above, wherein the transmission configuration indication state of the first and the second control resource sets is corresponding to the user specific search space sets is associated with a physical cell identification different from that of a serving cell.

In accordance with the example embodiments as described in the paragraphs above, wherein the selecting the first control resource set comprises selecting a control resource set corresponds to at least one of a common search space set or a user specific search space set with a lowest index in a cell with a lowest index as compared to other cells of the communication network.

In accordance with the example embodiments as described in the paragraphs above, wherein when there is no at least one control resource set corresponds to a common search space in the active downlink bandwidth part of one or more cells, the cell with a lowest index that is selected does not have a control resource set corresponding to the user specific search space associated with a physical cell identification different from that of the cell.

In accordance with the example embodiments as described in the paragraphs above, wherein the selecting the first control resource set comprises selecting a control resource set corresponds to the common search space set with a lowest index in a cell with a lowest index as compared to other cells of the communication network that have a control resource set corresponding to the user specific search space associated with a physical cell identification different from that of the cell

In accordance with the example embodiments as described in the paragraphs above, wherein the user specific search space is associated with a physical cell identification different from that of the cell and containing a common search space.

In accordance with the example embodiments as described in the paragraphs above, wherein the selecting the first control resource set comprises selecting a control resource set with a lowest index in a cell as compared to other cells of the communication network that do not have a control resource set corresponding to the user specific search space associated with a physical cell identification different from that of the cell and containing a common search space.

In accordance with the example embodiments as described in the paragraphs above, wherein the selecting the first control resource set comprises selecting a control resource set with a lowest user specific search space as compared to other cells of the communication network that do not have a control resource set corresponding to the user specific search space associated with a physical cell identification different from that of the cell and containing a common search space.

In accordance with the example embodiments as described in the paragraphs above, wherein the selecting comprises selecting any control resource set of two or more control resource sets having the same QCL-TypeD.

A non-transitory computer-readable medium (Memory(ies) 125 as in FIG. 5) storing program code (Computer Program Code 123 and/or Selection Module 140-2 as in FIG. 5), the program code executed by at least one processor (Processor(s) 120 and/or Selection Module 140-1 as in FIG. 5) to perform the operations as at least described in the paragraphs above.

In accordance with an example embodiment of the invention as described above there is an apparatus comprising: means for determining (one or more transceivers 130, Memory(ies) 125, Computer Program Code 123 and/or PRS Module 140-2, and Processor(s) 120 and/or PRS Module 140-1 as in FIG. 5), by a network device (UE 110 as in FIG. 5) of a communication network (Network 100 as in FIG. 5), to monitor (one or more transceivers 130, Memory(ies) 125, Computer Program Code 123 and/or PRS Module 140-2, and Processor(s) 120 and/or PRS Module 140-1 as in FIG. 5) physical downlink control channel candidates in overlapping monitoring occasions of two or more control resource sets of the communication network, wherein the two or more control resource sets are using at least two different QCL-TypeD on an active downlink bandwidth part of one or more cells; means for selecting (one or more transceivers 130, Memory(ies) 125, Computer Program Code 123 and/or PRS Module 140-2, and Processor(s) 120 and/or PRS Module 140-1 as in FIG. 5) a first control resource set using a first QCL-TypeD and a second control resource set using a second QCL-TypeD for monitoring at least two of the physical downlink control channel candidates, wherein the selection of the first control resource set is based on common search space sets and/or user specific search space sets of at least one control resource set on active downlink bandwidth part of at least one cell that associated with one or more physical cell identifiers, and the selection of the second control resource set is based on user specific search space sets of at least one control resource set on active downlink bandwidth part of at least one cell that associated with at least two physical cell identifiers.

In the example aspect of the invention according to the paragraph above, wherein at least the means for determining, monitoring, and selecting comprises a non-transitory computer readable medium [Memory(ies) 125 as in FIG. 5] encoded with a computer program [Computer Program Code 123 and/or Selection Module 140-2 as in FIG. 5] executable by at least one processor [Processor(s) 120 and/or Selection Module 140-1 as in FIG. 5].

Further, in accordance with example embodiments of the invention there is circuitry for performing operations in accordance with example embodiments of the invention as disclosed herein. This circuitry can include any type of circuitry including content coding circuitry, content decoding circuitry, processing circuitry, image generation circuitry, data analysis circuitry, etc.). Further, this circuitry can include discrete circuitry, application-specific integrated circuitry (ASIC), and/or field-programmable gate array circuitry (FPGA), etc. as well as a processor specifically configured by software to perform the respective function, or dual-core processors with software and corresponding digital signal processors, etc.). Additionally, there are provided necessary inputs to and outputs from the circuitry, the function performed by the circuitry and the interconnection (perhaps via the inputs and outputs) of the circuitry with other components that may include other circuitry in order to perform example embodiments of the invention as described herein.

In accordance with example embodiments of the invention as disclosed in this application this application, the “circuitry” provided can include at least one or more or all of the following:
(a) hardware-only circuit implementations (such as implementations in only analog and/or digital circuitry);
(b) combinations of hardware circuits and software, such as (as applicable):
   (i) a combination of analog and/or digital hardware circuit(s) with software/firmware; and
   (ii) any portions of hardware processor(s) with software (including digital signal processor(s)), software, and memory(ies) that work together to cause an apparatus, such as a mobile phone or server, to perform various functions, such as functions or operations in accordance with example embodiments of the invention as disclosed herein); and
(c) hardware circuit(s) and or processor(s), such as a microprocessor(s) or a portion of a microprocessor(s), that requires software (e.g., firmware) for operation, but the software may not be present when it is not needed for operation.”

In accordance with example embodiments of the invention, there is adequate circuitry for performing at least novel operations as disclosed in this application, this ‘circuitry’ as may be used herein refers to at least the following:
(a) hardware-only circuit implementations (such as implementations in only analog and/or digital circuitry); and
(b) to combinations of circuits and software (and/or firmware), such as (as applicable): (i) to a combination of processor(s) or (ii) to portions of processor(s)/software (including digital signal processor(s)), software, and memory(ies) that work together to cause an apparatus, such as a mobile phone or server, to perform various functions); and
(c) to circuits, such as a microprocessor(s) or a portion of a microprocessor(s), that require software or firmware for operation, even if the software or firmware is not physically present.

This definition of ‘circuitry’ applies to all uses of this term in this application, including in any claims. As a further example, as used in this application, the term “circuitry” would also cover an implementation of merely a processor (or multiple processors) or portion of a processor and its (or their) accompanying software and/or firmware. The term “circuitry” would also cover, for example and if applicable to the particular claim element, a baseband integrated circuit or applications processor integrated circuit for a mobile phone or a similar integrated circuit in a server, a cellular network device, or other network device.

In general, the various embodiments may be implemented in hardware or special purpose circuits, software, logic or any combination thereof. For example, some aspects may be implemented in hardware, while other aspects may be implemented in firmware or software which may be executed by a controller, microprocessor or other computing device, although the invention is not limited thereto. While various aspects of the invention may be illustrated and described as block diagrams, flow charts, or using some other pictorial representation, it is well understood that these blocks, apparatus, systems, techniques or methods described herein may be implemented in, as non-limiting examples, hardware, software, firmware, special purpose circuits or logic, general purpose hardware or controller or other computing devices, or some combination thereof.

Embodiments of the inventions may be practiced in various components such as integrated circuit modules. The design of integrated circuits is by and large a highly automated process. Complex and powerful software tools are available for converting a logic level design into a semiconductor circuit design ready to be etched and formed on a semiconductor substrate.

The word “exemplary” is used herein to mean “serving as an example, instance, or illustration.” Any embodiment described herein as “exemplary” is not necessarily to be construed as preferred or advantageous over other embodiments. All of the embodiments described in this Detailed Description are exemplary embodiments provided to enable persons skilled in the art to make or use the invention and not to limit the scope of the invention which is defined by the claims.

The foregoing description has provided by way of exemplary and non-limiting examples a full and informative description of the best method and apparatus presently contemplated by the inventors for carrying out the invention. However, various modifications and adaptations may become apparent to those skilled in the relevant arts in view of the foregoing description, when read in conjunction with the accompanying drawings and the appended claims. However, all such and similar modifications of the teachings of this invention will still fall within the scope of this invention.

It should be noted that the terms “connected,” “coupled,” or any variant thereof, mean any connection or coupling, either direct or indirect, between two or more elements, and may encompass the presence of one or more intermediate elements between two elements that are “connected” or “coupled” together. The coupling or connection between the elements can be physical, logical, or a combination thereof. As employed herein two elements may be considered to be “connected” or “coupled” together by the use of one or more wires, cables and/or printed electrical connections, as well as by the use of electromagnetic energy, such as electromagnetic energy having wavelengths in the radio frequency region, the microwave region and the optical (both visible and invisible) region, as several non-limiting and non-exhaustive examples.

Furthermore, some of the features of the preferred embodiments of this invention could be used to advantage without the corresponding use of other features. As such, the foregoing description should be considered as merely illustrative of the principles of the invention, and not in limitation thereof.

1-44. (canceled)

45. An apparatus of a communication network, comprising:
at least one processor; and
at least one memory storing instructions that, when executed with the at least one processor, cause the apparatus to at least:
determine, with the apparatus, to monitor physical downlink control channel candidates in overlapping monitoring occasions of two or more control resource sets of the communication network,
wherein the two or more control resource sets are using at least two different QCL-TypeD on an active downlink bandwidth part of one or more cells; and
select a first control resource set using a first QCL-TypeD and a second control resource set using a second QCL-TypeD for monitoring at least two of the physical downlink control channel candidates,
wherein the selection of the first control resource set is based on at least one of: common search space sets or user specific search space sets of at least one control resource set on active downlink bandwidth part of at least one cell that associated with one or more physical cell identifiers, and the selection of the second control resource set is based on user specific search space sets of at least one control resource set on active downlink bandwidth part of at least one cell that associated with at least two physical cell identifiers.

46. The apparatus of claim 45, wherein the instructions, when executed with the at least one processor, cause the apparatus to monitor physical downlink control channel candidates in overlapping monitoring occasions of the two or more control resource sets associated with the first QCL-typeD and second QCL-typeD.

47. The apparatus of claim 46, wherein the first and the second control resource sets have been activated with transmission configuration indication states.

48. The apparatus of claim 47, wherein the transmission configuration indication states comprise at least one of a joint transmission configuration indication state or a downlink transmission configuration indication state associated with the at least two different qcl-Type set to typeD properties.

49. The apparatus of claim 48, wherein the transmission configuration indication state of the first and the second control resource sets corresponding to the user specific search space sets is associated with a physical cell identification different from that of a serving cell.

50. The apparatus of claim 45, wherein the instructions, when executed with the at least one processor, cause the apparatus to select a control resource set corresponding to at least one of a common search space set or a user specific search space set with a lowest index in a cell with a lowest index as compared to other cells of the communication network.

51. The apparatus of claim 50, wherein when there is no at least one control resource set corresponding to a common search space in the active downlink bandwidth part of one or more cells, the cell with a lowest index that is selected does not have a control resource set corresponding to the user specific search space associated with a physical cell identification different from that of the cell.

52. The apparatus of claim 50, wherein the instructions, when executed with the at least one processor, cause the apparatus to select a control resource set corresponding to the common search space set with a lowest index in a cell with a lowest index as compared to other cells of the communication network that have a control resource set corresponding to the user specific search space associated with a physical cell identification different from that of the cell.

53. The apparatus of claim 52, wherein the user specific search space is associated with a physical cell identification different from that of the cell and containing a common search space.

54. The apparatus of claim 50, wherein the instructions, when executed with the at least one processor, cause the apparatus to select any control resource set of two or more control resource sets having the same QCL-TypeD.

55. The apparatus of claim 45, wherein the instructions, when executed with the at least one processor, cause the apparatus to select a control resource set with a lowest index in a cell as compared to other cells of the communication network that do not have a control resource set corresponding to the user specific search space associated with a physical cell identification different from that of the cell and containing a common search space.

56. The apparatus of claim 45, wherein the instructions, when executed with the at least one processor, cause the apparatus to select a control resource set with a lowest user specific search space as compared to other cells of the communication network that do not have a control resource set corresponding to the user specific search space associated with a physical cell identification different from that of the cell and containing a common search space.

57. A method of a communication network, comprising:
determining, with a network device, to monitor physical downlink control channel candidates in overlapping monitoring occasions of two or more control resource sets of the communication network,
wherein the two or more control resource sets are using at least two different QCL-TypeD on an active downlink bandwidth part of one or more cells; and
selecting a first control resource set using a first QCL-TypeD and a second control resource set using a second QCL-TypeD for monitoring at least two of the physical downlink control channel candidates,
wherein the selection of the first control resource set is based on at least one of: common search space sets or user specific search space sets of at least one control resource set on active downlink bandwidth part of at least one cell that associated with one or more physical cell identifiers, and the selection of the second control resource set is based on user specific search space sets of at least one control resource set on active downlink bandwidth part of at least one cell that associated with at least two physical cell identifiers.

58. The method of claim 57, further comprising monitoring physical downlink control channel candidates in overlapping monitoring occasions of the two or more control resource sets associated with the first QCL-typeD and second QCL-typeD.

59. The method of claim 58, wherein the first and the second control resource sets have been activated with transmission configuration indication states.

60. The method of claim 59, wherein the transmission configuration indication states comprise at least one of a joint transmission configuration indication state or a downlink transmission configuration indication state associated with the at least two different qcl-Type set to typeD properties.

61. The method of claim 60, wherein the transmission configuration indication state of the first and the second control resource sets corresponding to the user specific search space sets is associated with a physical cell identification different from that of a serving cell.

62. The method of claim 57, wherein the selecting the first control resource set comprises selecting a control resource set corresponding to at least one of a common search space set or a user specific search space set with a lowest index in a cell with a lowest index as compared to other cells of the communication network.

63. The method of claim 62, wherein the selecting comprises selecting any control resource set of two or more control resource sets having the same QCL-TypeD.

64. The method of claim 62, wherein the selecting the first control resource set comprises selecting a control resource set corresponds to the common search space set with a lowest index in a cell with a lowest index as compared to other cells of the communication network that have a control resource set corresponding to the user specific search space associated with a physical cell identification different from that of the cell.
